(19) United States
(12) Patent Application Publication
(10) Pub. No.: US 2021/0333438 A1
(43) Pub. Date: Oct. 28, 2021

(54) MULTILAYER ANTIREFLECTIVE ARTICLE AND METHODS OF FORMING THE SAME

(71) Applicant: General Plasma Inc., Tucson, AZ (US)

(72) Inventor: Phong NGO, Tucson, AZ (US)

(21) Appl. No.: 16/614,165

(22) PCT Filed: May 22, 2018
(86) PCT No.: PCT/US2018/033883

§ 371 Date: Nov. 15, 2019

Related U.S. Application Data
(60) Provisional application No. 62/509,296, filed on May 22, 2017.

(51) Int. Cl. G02B 1/118; G02B 5/28

(52) U.S. Cl. CPC G02B 1/118; G02B 5/285

(57) ABSTRACT

Multilayer antireflective articles are disclosed. In embodiments, the multilayer antireflective articles include a combination of a moth-eye layer and a multi-layer antireflective stack. The articles can exhibit desirable optical properties for use in various applications, including screen overlays. Methods of forming such articles are also disclosed.

### FIELD

The present disclosure generally relates to multilayer antireflective articles and methods of forming the same. In particular, the present disclosure relates to multilayer antireflective articles that include a combination of a moth-eye layer and a multi-layer antireflective stack.

### BACKGROUND

Electronic devices such as computer monitors, smart phones, tablet computers, laptops, etc. include a display for conveying information to a user of the device. In many instances such displays include a cover layer (e.g., of glass or another material) for the protection of underlying components of the device, and/or to provide an interface (e.g., touch screen) through which a user may interact with the device. Although useful, such cover layers can reflect an undesirable amount of incident light when the device is used outdoors or in another highly illuminated environment. Uncoated glass, for example, can reflect more than 4% of incident light in the visible region of the electromagnetic spectrum. That property can make it challenging for a user of a mobile device that includes uncoated glass as a cover layer of a display to view content on the display in certain lighting conditions. Uncoated glass can also undesirably reduce the color contrast of the display.

Using an antireflective (AR) coating on the cover layer of a display can effectively address the above noted problems and can enhance user experience in mobile display applications such as smart phones, tablets and automotive computer screens. Due to the challenging environments in which such devices are utilized and stringent durability specifications, however, AR coatings are rarely used in such applications. This is in part due to the economic risk to the manufacturer of having to replace the device or device screen in the case where the AR coating is damaged.

One alternative to depositing an AR coating directly on a cover layer (glass) of a display is to apply an antireflective overlay to the cover layer. However, current AR overlays suffer from coating adhesion problems and relatively poor durability, and thus may be unsuitable for many applications. For example, smart phones and other mobile devices are often used in hot and humid environments, and their display surface is frequently touched. Due to their relatively low durability and poor adhesion, many currently known AR coatings and overlays are unable to withstand such conditions.

### BRIEF DESCRIPTION OF THE DRAWINGS

FIG. 1A is a cross-sectional diagram schematically illustrating an example layer structure of one example of a multi-layer antireflective article consistent with the present disclosure;

FIG. 1B is a magnified cross-sectional view of one example of an antireflective stack consistent with the present disclosure.

FIG. 2 is a schematic drawing of one example of an ion beam plasma etch process that may be used to create a moth eye layer.

FIG. 3 is an SEM image depicting partial formation of a moth eye layer in a hard coating, consistent with the present disclosure.

FIG. 4 is a magnified SEM image depicting the surface topology of a moth eye layer consistent with the present disclosure.

FIGS. 5A-5E stepwise illustrate the formation of one example of a multi-layer anti-reflective article consistent with the present disclosure.

FIG. 6 is an SEM image showing the topology of one example of a surface of an adhesion layer on a moth eye layer, consistent with the present disclosure;

FIG. 7 is a comparison plot of light reflectance (in percent) versus wavelength (in nanometers) for a layer stack before the formation of a moth eye layer, a layer stack after formation of a moth eye layer, and a layer stack after formation of an adhesion layer on a moth eye layer;

FIG. 8A is a cross-sectional diagram schematically illustrating an example layer structure of another example of a multi-layer antireflective article consistent with the present disclosure;

FIG. 8B is an SEM image showing the surface topology of an upper surface of one example of an AR stack on an adhesion layer consistent with the present disclosure.

FIG. 9 is a plot of reflectance (in percent) versus wavelength (in nanometers) exhibited by one example of a multi-layer antireflective article consistent with the present disclosure, as applied to a surface of a display of a mobile device.

FIG. 10 is comparison plot of light reflectance (in percent) versus wavelength (in nanometers) and illustrates a difference between simulated and actual performance of a multilayer antireflective article consistent with the present disclosure.

### DETAILED DESCRIPTION

The present disclosure generally relates to multilayer antireflective (AR) articles and methods for making the same. Such articles may exhibit a desirable combination of low visible light reflectance, high durability, and strong adhesion, making them well suited for mobile device and other applications. In particular, the multilayer AR articles described herein are suitable for use as an AR overlay for the display of a mobile device or an automobile.

In embodiments the multilayer AR articles consistent with the present disclosure include a base structure, a moth eye layer, an adhesion layer, and an AR stack. The base structure includes a substrate and a hard-coat layer on an upper surface of the substrate. The moth eye layer is plasma etched into and integral with the upper surface of the hard coat layer. The adhesion layer is disposed on the moth eye layer. The AR stack is disposed on the adhesion layer and includes a plurality of layers of differing refractive index. In some instances, the multilayer AR article further includes an anti-smudge layer on an upper surface of the AR stack. The base structure may also include an optional adhesive layer and optional release liner, so as to facilitate application of the multilayer AR article to a surface of a display. Mobile devices including a display and a multilayer AR article consistent with the present disclosure on the display are also described.

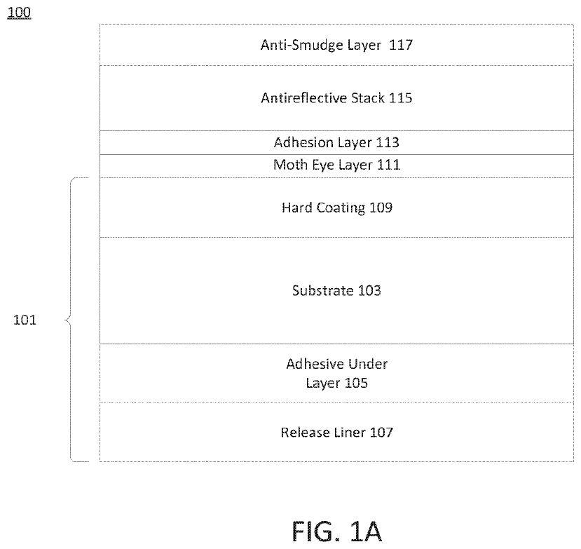

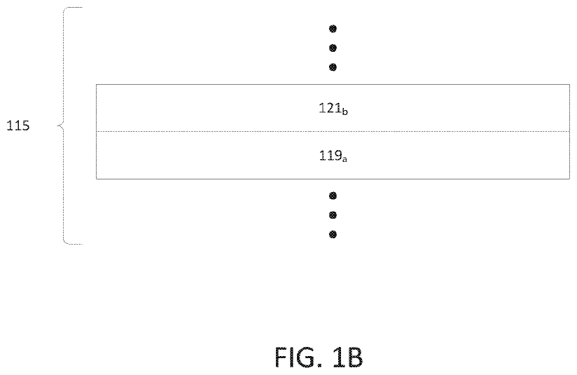

FIG. 1A is a cross sectional diagram that schematically illustrates an example layer structure of one example of a multi-layer antireflective (AR) article 100 consistent with the present disclosure. As shown, the multilayer AR article 100 includes a base structure 101, a moth eye layer 111, an adhesion layer 113, and an antireflective (AR) stack 115. As shown in FIG. 1B, the AR stack 115 includes a plurality of alternating layers 119ₐ, 121_{b} of different refractive indexes.

The base structure 101 generally includes a substrate 103 and a hard coating 109 on (e.g., directly on) an upper surface thereof. The substrate 103 may be flexible or rigid and may be formed from any suitable material. In some embodiments the substrate 103 is or includes a polymer, wherein the polymer is formed from or includes an acrylate polymer or copolymer, a terephthalate polymer or copolymer, or a combination thereof. Without limitation, in some embodiments the substrate 103 is a methacrylate film or a polyethylene terephthalate (PET) film.

The thickness of the substrate 103 may vary widely. In some embodiments substrate 103 is a polymer film such as those noted above, wherein the thickness of the polymer film ranges from greater than 0 to about 5 millimeters (mm) or more, such as from greater than 0 to about 1 mm, from greater than 0 to about 250 microns (μm), from greater than 0 to about 150 μm, or even from about 10 to about 100 μm. In some embodiments the substrate 103 is a PET film having a thickness of about 50 to about 150 μm, such as a PET film having a thickness of about 100 μm.

As noted above the base structure 101 includes a hard coating 109 formed on (e.g., directly on) an upper surface of the substrate 103. Among other things, one purpose of the hard coating 109 is to improve the scratch and abrasion resistance of the substrate 103.

A wide variety of hard coatings for polymeric materials are known, and any suitable hard coating composition may be used as the hard coating 109. Non-limiting examples of suitable hard coatings that may be used as hard coating 109 include alkoxide hard coatings such as hard coatings formed from a precursor of a metal alkoxide (e.g., a silicon alkoxide precursor), oxide hard coatings such as SiOₓ hard coatings (where x ranges from greater than 0 to 2) and SiO₂ polymeric composite hard coatings, silicon oxynitride hard coatings (e.g., SiOₓN_{y}), combinations thereof, and the like. Without limitation, in some embodiments the hard coating 109 is formed from or includes a silicon and oxygen containing hard coating, such as but not limited to a silicon alkoxide hard coating and/or a silicon oxide polymeric hard coating. Such hard coatings may be applied in any suitable manner, such as by a wet-coating process.

The thickness of the hard coating 109 may vary widely, and hard coatings of any suitable thickness may be used. In embodiments the hard coating 109 has a thickness ranging from greater than 200 nm to about 20 μm or more. Without limitation, in some embodiments the hard coating 109 is a silicon and oxygen containing hard coating having a thickness of about 5 microns.

The hardness of the base structure may vary widely, and base structures with any suitable hardness may be used. In embodiments the base structure includes at least a substrate 103 and a hard coating 109 (e.g., a silicon and oxygen containing hard coating), and exhibits a pencil hardness ranging from about 1 to 5H, such as about 3H.

The base structure 101 may further include an optional adhesive layer 105. When used, the optional adhesive layer 105 may enhance the coupling/adherence of the multilayer AR article 100 to the surface of a display. A wide variety of adhesives may be used as or in the optional adhesive layer 105. Non-limiting examples of such adhesives include high and low tack adhesives, which may be formed from or include one or more silicone adhesives, acrylic adhesives, synthetic block copolymer adhesives, combinations thereof, and the like. In some embodiments the optional adhesive layer 105 is formed from or includes a repositionable adhesive, such as but not limited to a repositionable adhesive that may permit multilayer AR article 100 to be removed from the surface of a display of a mobile or other electronic device without leaving an adhesive residue. Without limitation, in some embodiments the optional adhesive layer 105 is a silicone adhesive that is configured to provide a bubble free, low tack attachment to a display of a mobile device. An optional release liner 107 may be also be used, e.g., to facilitate handling of a multilayer AR article 100 that includes an optional adhesive layer 105, and to protect the adhesive layer 105 prior to the installation of multilayer AR article 100 installation on a display.

The multilayer AR article 100 further includes a moth eye layer 111 that is formed by etching the upper surface of the hard coating 109 to form moth eye structures. In such instances it should be understood that the moth eye layer 111 is not a “layer” that is discrete from the hard coating 109, but rather is a region of the hard coating 109 that has been etched or otherwise processed to include moth eye structures.

The moth eye layer is configured to produce an optical effect that can reduce incident light reflection from a surface. Moth eye structures are small, repeated features that are like the natural anti-reflective structures found in the eye of a moth and include arrays of protuberances and cavities having individual feature dimensions of less than half wavelength (λ/2) or the diffraction limit of incident light. As the wave of incident light passing through air encounters moth eye structures, part of the light encounters the material forming the structure (i.e., hits a protuberance) and part continues in air (i.e., within a cavity). The resulting graded or transitional encounter with the moth eye layer material creates an intermediate effective refractive index ‘layer’ that is between the refractive index of air and of the material forming the protuberances, and therefore lowers the amount of incident light that is reflected from the moth eye layer.

Within the moth eye layer dimensional constraints, this intermediate effective refractive index is determined by a ratio of material cross section areas encountered by the incoming light. This ratio is referred to herein as the “Fill Factor,” where Fill Factor=(total surface area−total cavity area)/(the total surface area) in percent. Using that ratio, the effective refractive index (ERI) of the moth eye layer may be approximated by: ERI=n1*(1−% A)+n2*% A, where n1 is the refractive index of air (or a material filling the moth eye cavities), n2 is the refractive index of the moth eye layer material and % A=% Fill Factor. For instance, for a moth eye structure with a Fill Factor (% A) of 65% and n1=1 for air and n2=1.55 for hard coated PET plastic, the resulting intermediate refractive index would be 1.36. This intermediate index layer between air and the substrate material can reduce visible light reflection at the surface of the moth eye layer to 2.5% or less. In contrast, the reflection of visible light from a hard-coated PET material without moth eye structures may be 4.5% or more.

If the Fill Factor is large due to insufficient cavity size or because the cavities in the moth eye layer are fully or partially filled by subsequent layers, the effect on the amount of light reflection is considerable. This is because when the cavities in the moth eye layer are filled (e.g., by conformal or other layers), the interface between the air and the surface of the article moves from the moth eye layer to the surface of the outermost layer of the article. That can substantially diminish the moth eye effect and limit the amount by which visible light reflection may be reduced. In such instances any remaining moth eye effect can be determined by the refractive index of the surface material and the Fill Factor as described above. For instance, if the cavities were largely filled by a conformal silicon dioxide layer (refractive index of 1.48) and the Fill Factor was increased 90%, the resulting effective refractive index of the interface would be 1.43 as per the foregoing equations. Incident light reflection from the surface of such an article would be greater than 4% —which is substantially higher than the light reflection exhibited by the moth eye layer itself. Notably, the depth of a moth eye structure generally equates to the thickness of the created effective low index moth eye layer.

In embodiments the term “moth eye structures” is used herein to refer to a plurality of cavities that are etched into or otherwise formed into an upper surface of hard coating 109, and which reduce the reflection of incident light via anti-reflection, e.g., in a manner similar to the natural anti-reflective structures found in the eye of a moth. In embodiments the moth eye layer 111 is formed by subjecting the upper surface of the hard coating 109 to a plasma etch process. The plasma etch process may etch or otherwise remove portions of the hard coating 109, resulting in the formation of moth eye structures therein/thereon and, consequently, the formation of moth eye layer 111.

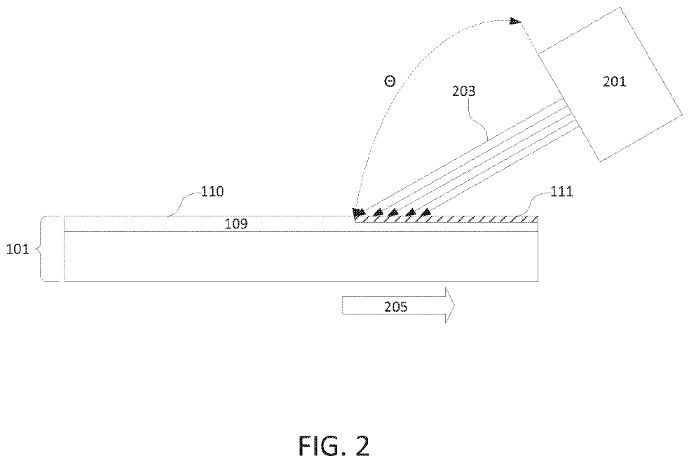

Reference is now made to FIGS. 2-4. FIG. 2 is a schematic depicting the conversion of at least a portion the hard coating 109 of base structure 101 into a moth eye layer 111 using a plasma etch apparatus 201. The plasma etch apparatus 201 includes a linear ion source that is configured to generate a collimated ion beam 203. Example linear ion sources that may be used include anode layer type linear ion sources, such as but not limited to the GENERAL PLASMA™ PPALS36 anode layer ion source.

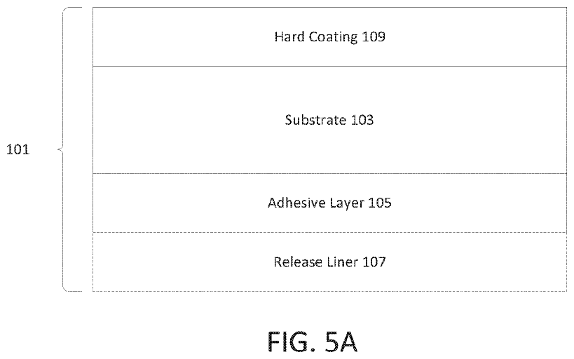

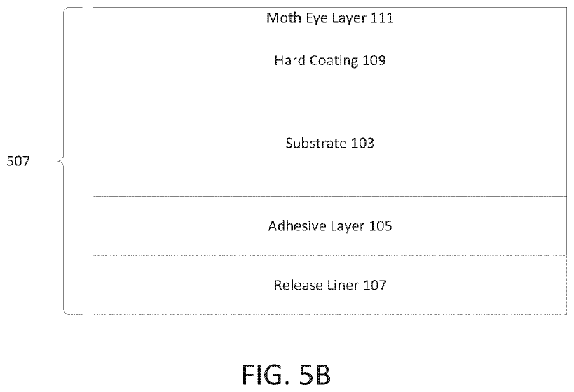

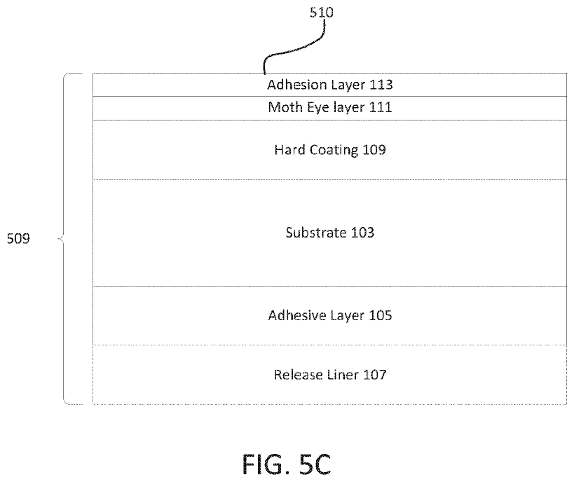

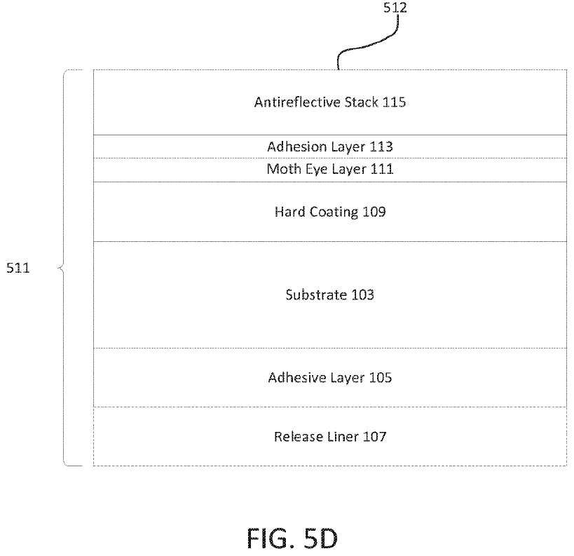

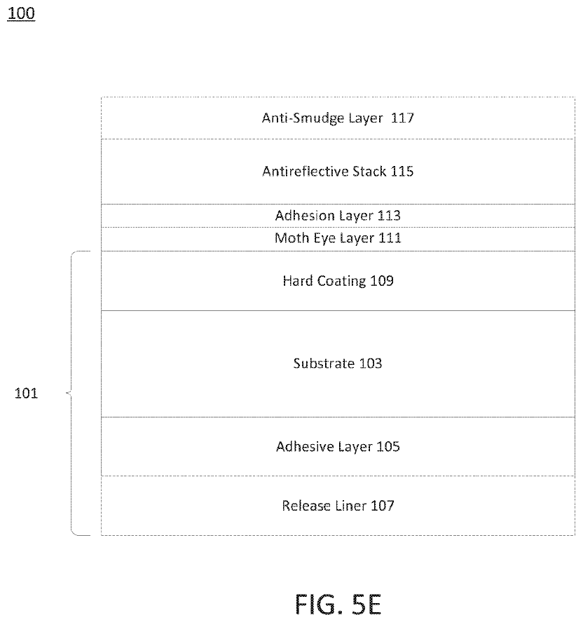

To form moth eye layer 111, a base structure 101 consistent with FIG. 5A may be placed in a vacuum chamber (not shown). The vacuum chamber may contain the plasma etch apparatus 201 or at least the ion source (not separately shown) thereof. The ion source of the plasma etch apparatus 201 may be operable to emit a collimated ion beam 203 towards base structure 101 or, more specifically, towards an upper surface of the hard coating 109. In embodiments, the ion beam 203 is or includes oxygen ions, though other ions may also be used depending on the composition of the hard coating 109. As the base structure 101 is moved relative to the plasma etch apparatus 201 (e.g., in direction 205), the ion beam 203 mechanically sputters off at least a portion of the hard coating 109, and/or chemically reacts with the hard coating 109 in a region proximate the upper surface thereof, thereby resulting in the formation of moth eye layer 111. In some embodiments the hard coating 109 is or includes a silicon and oxygen containing polymeric hard coating, and the ion beam 203 removes polymeric carbon and hydrogen components from the hard coating 109, thereby producing a moth eye layer 111 in the form of etched cavities and an exposed network of or containing silicon oxide and/or silicon dioxide on upper surface of hard coating 109.

The angle at which ions in the ion beam 203 is incident on the surface of the hard coating 109 (i.e., the incidence angle of ion beam 203) may impact the structural features of the resultant moth eye layer 111 and, thus, the moth eye optical effect and adhesion of layers that are subsequently formed on the moth eye layer 111. It may therefore be desirable to control the incidence angle θ of the ion beam 203 on the upper surface of the hard coating 109 such that the ions in ion beam 203 are incident on the upper surface of the hard coating 109 within a desired incidence angle range, or even at a specific desired incidence angle. In embodiments, the incidence angle θ of the ion beam 203 on the surface of the hard coating 109 ranges from greater than 0 to about 75 degrees. Without limitation, in some embodiments the incidence angle θ of the ion beam 203 is about 45 degrees.

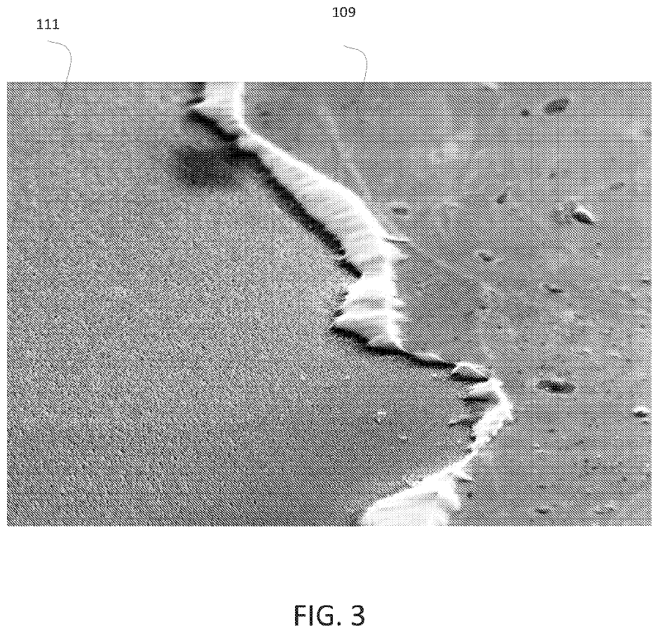

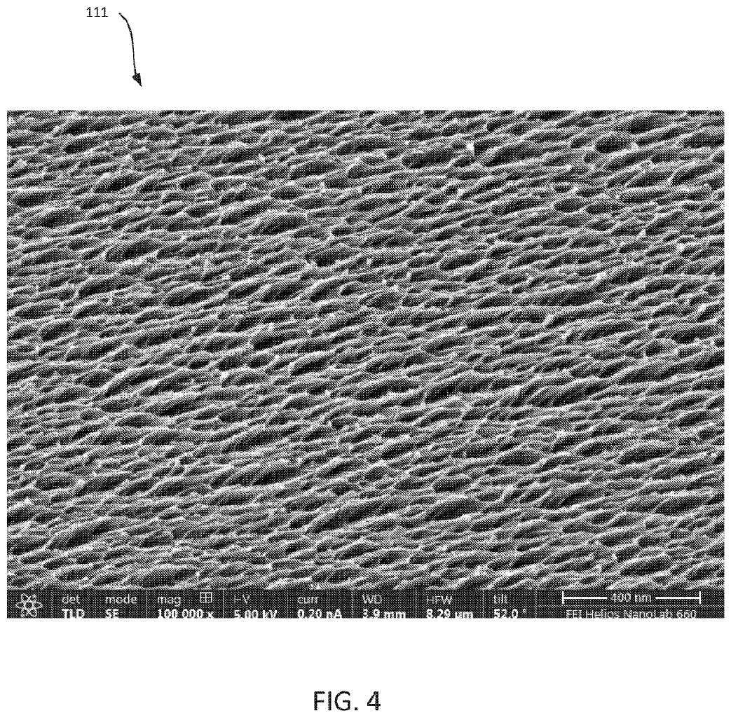

FIG. 3 is a scanning electron microscope (SEM) image depicting moth eye structures formed in a portion of one example of a hard coating 109 consistent with the present disclosure via a plasma etch process. The right side of the figure shows the untreated surface of a silicon oxide polymeric hard coating 109 formed on a PET substrate 103. The left side of the figure shows moth eye structures of the moth eye layer 111 formed by exposing the hard coating 109 to a beam of oxygen ions that were incident on the surface of the hard coating 109 at an incidence angle of 45 degrees. The oxygen ions were generated by operating an ion source of a plasma etch apparatus 201 at a voltage of 2500V with an ion source power supply discharge current of 400 milli-amperes (mA) using oxygen gas. The substrate was moved past the ion source at a rate of 0.5 meters (m) per minute. The pressure in the vacuum chamber was less than 1 mTorr. Further detail of the surface of the moth eye layer 111 can be seen in FIG. 4, which is an SEM image of a portion of the moth eye layer of FIG. 3 at higher magnification. Formation of the moth eye layer 111 may be completed by moving the base structure 101 relative to the ion source, moving the ion source relative to the base structure, or both.

FIGS. 3 and 4 demonstrate that the plasma etch process significantly alters the upper surface of the hard coating layer 109, resulting in the formation of the moth eye layer 111. The surface features of the moth eye layer 111 provide a beneficial moth-eye reflection reducing effect and aid in enhancing the adhesion of subsequent layers to base substrate 101.

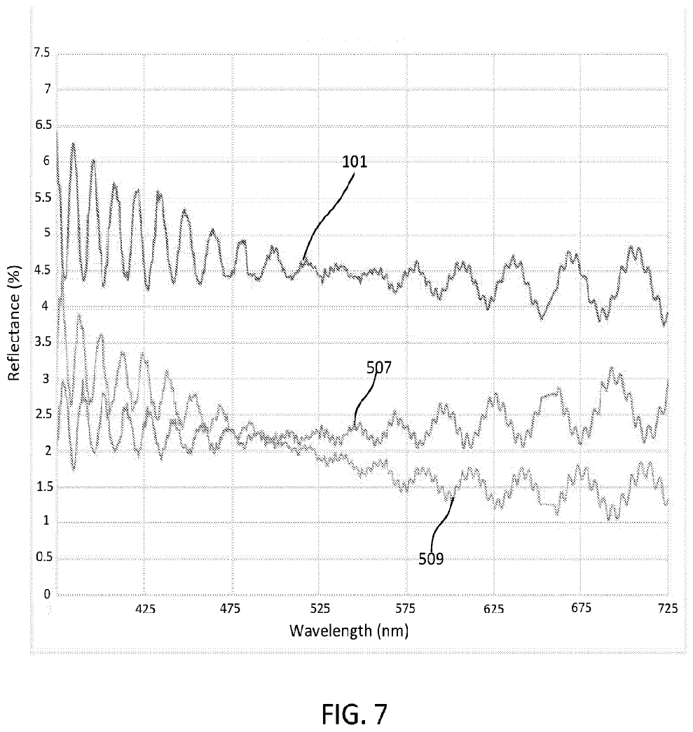

Scaling the SEM image of FIG. 4, the moth eye structure cavity opening dimensions are approximately 30-60 nm in the y-direction and 60-120 nm in the x-direction. Fill Factor of the surface area relative to the cavity area in can be estimated to be about 40%-70%. More accurately, the Fill Factor of moth eye layer 111 can be determined from data in FIG. 7 by optical modeling comparing the light reflectance of the base substrate 101 and the reflectance 507 of the moth eye layer 111. For the moth eye structure as described above, the Fill Factor is 65%.

Following plasma etch an intermediate product including a layer stack 507 as shown in FIG. 5B may be obtained. The intermediate product including the layer stack 507 may then be subject to further processing to form one or more additional layers on the upper surface of the moth eye layer 111. For example, in some embodiments following the plasma etch an adhesion layer 113 may be formed on an upper surface of the moth eye layer 111. The composition of the adhesion layer 113 may vary widely, and any suitable adhesion layer composition may be used. Non-limiting examples of suitable adhesion layer compositions include metal oxide adhesion layers (e.g., TiOₓ and SiOₓ), metal oxynitride adhesion layers, combinations thereof, and the like. Without limitation, in some embodiments the adhesion layer 113 is a SiOₓ containing adhesion layer, such as but not limited to silicon oxide and silicon dioxide.

The adhesion layer 113 may be formed in any suitable manner, such as but not limited to plasma enhanced chemical vapor deposition (PE-CVD). In some embodiments, the adhesion layer 113 is a SiOₓ adhesion layer that is formed by PE-CVD. Such deposition may be accomplished in a vacuum or other chamber using any suitable PE-CVD apparatus, such as but not limited to a PE-CVD apparatus that utilizes the alternating current (AC) ion source described in U.S. Pat. No. 9,136,086. Such an AC ion source can be used to deposit metal oxide films like SiOₓ and TiOₓ via PE-CVD at high rates and with good density, uniformity and stability.

In some embodiments, the adhesion layer 113 is a SiOₓ adhesion layer formed by PE-CVD using HMDSO (hexamethyldisiloxane) as a precursor vapor and oxygen and argon gases. Of course, materials other that SiOₓ and other precursor vapors may be used. In any case, following formation of the adhesion layer 113 an intermediate product including a layer stack 509 consistent with FIG. 5C may be formed.

The thickness of the adhesion layer 113 may vary widely, and adhesion layers 113 having any suitable thickness may be used. In some embodiments, the thickness of the adhesion layer 113 ranges from greater than 10 to about 75 nanometers. In some embodiments the adhesion layer is a SiOₓ adhesion layer and has a thickness of about 37 nm.

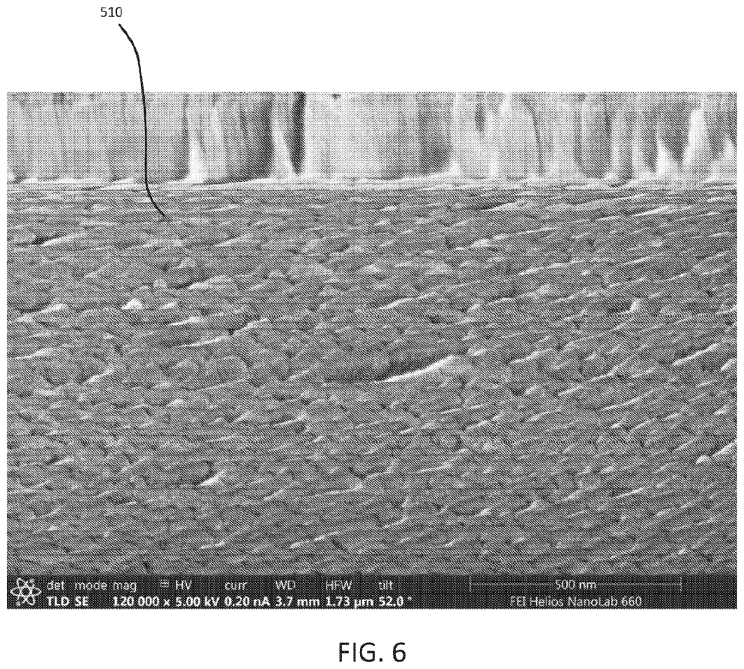

FIG. 6 is an SEM image of the upper surface 510 of a 37 nm SiO₂ adhesion layer 113 deposited on a moth eye layer 111. As can be seen, the surface of the moth eye structures has been modified by the adhesion layer and the surface roughness is reduced. By scaling the SEM image of FIG. 6, the Fill Factor of the surface area relative to the cavity area in this example is estimated to be about 90%.

FIG. 7 shows comparison plots of the measured reflectance of the base substrate 101, base substrate with moth eye layer 507 and the combined layers including adhesion layer 113 of 37 nm SiOₓ (509). As shown in FIG. 7, the base structure 101 reflected about 5.5% of incident light in the range of about 375 to about 475 nm, and about 4.0-4.5% of light in the range of about 475 to about 700 nm. In comparison, the measured optical reflectance of layer stack 507 reflected about 2 to 2.5% of light over the entire wavelength range of about 375 to about 700 nm, demonstrating the ability of the moth-eye layer to reduce the reflection of the incident light. The measured reflection of stack 509 demonstrates that the reflection reducing effect of the moth eye layer remained following the deposition of the SiOₓ adhesion layer 113. Specifically, the measured optical reflectance of layer stack 509 (including adhesion layer 113) reflected about 2.5-3.5% of light in the range of about 375 to about 475 nm, and from about 1 to about 2.5% of light in the range of about 475 to about 725 nm. Therefore, the addition of adhesion layer 113 to stack 507 increased the measured optical reflectance of layer stack 507 by about 1% in the range of about 375 to about 475 nm, and reduced the measured optical reflectance of light by about 1% in the range of about 475 to about 725 nm.

The measured reflection of stack 509 in FIG. 7 indicates that adhesion layer 113 is not conformally coated on the moth eye layer 111, and therefore does not fill (or does not significantly fill) the cavities of the moth eye layer 111. If the adhesion layer 113 conformally coated layer 111, the cavities of the moth eye layer 111 would be filled by the material of the adhesion layer 113 and the air/substrate interface would be moved to the surface of adhesion layer 113. The reduced roughness of layer 113 (relative to the moth eye layer 111) as shown in FIG. 6—with a Fill Factor of 90% —would result in an intermediate index of 1.43. Consequently, stack 509 would exhibit a surface reflectance of over 4%, rather than less than 2.5% as shown by the plot of the actual measured reflectance of stack 509 shown FIG. 7. The lower reflectance shown in the actual measurement of stack 509 indicates that adhesion layer 113 is not conformal to and does not significantly fill in the cavities of the moth eye layer 111. Rather it suggests that the cavities in moth eye layer 111 or its Fill Factor remain relatively unchanged, allowing moth eye layer 111 to remain an effective anti-reflection layer in the overall AR article 100.

Following the formation of the adhesion layer 113 a layer stack 509 as shown in FIG. 5C may be obtained. The layer stack 509 may then be subject to further processing to form additional layers thereon, such but not limited to AR stack 115 and optional anti-smudge layer 117. Layer stack 509 may also be considered a final product in some cases.

As shown in FIG. 1B, the AR stack 115 includes a plurality of layers of differing refractive index, including at least one first layer 119ₐ and at least one second layer 121_{b}, where and b are integers that identify one of the first and second layers 119ₐ, 121_{b}, and range from 1 to greater than 1 (e.g., 2 to 10). In some embodiments the first and second layers 119ₐ, 121_{b} have different refractive indexes. For example, the first layer(s) 119ₐ may have a higher refractive index than the second layer(s) 121_{b}, or vice versa. In general, the refractive indices of each of the first and second layers may range from greater than 1 to about 4.

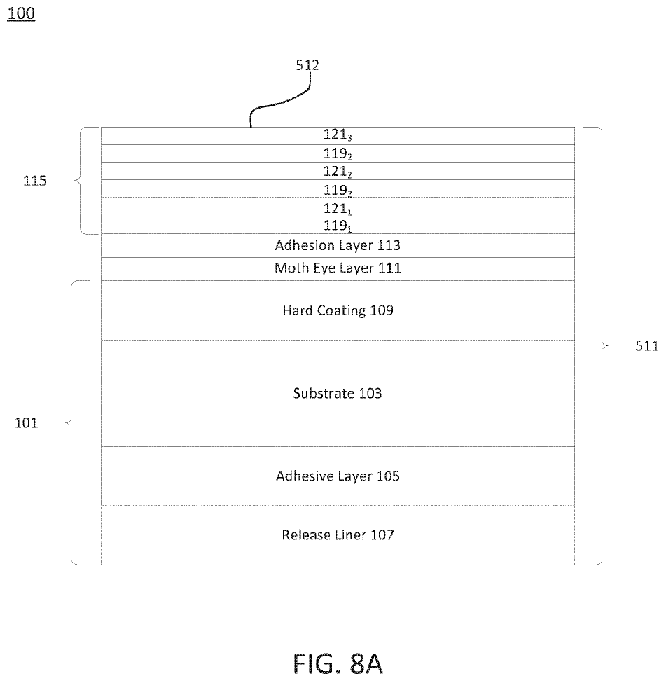

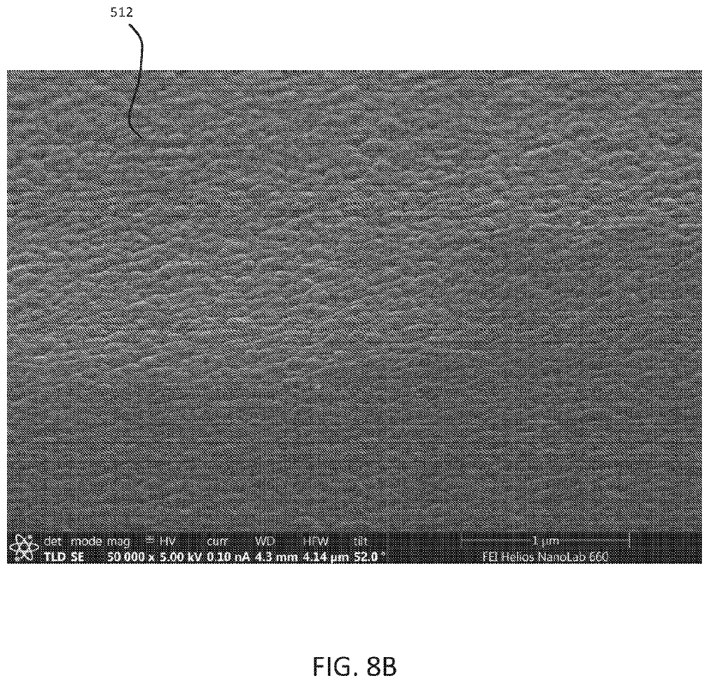

For simplicity FIG. 1B depicts AR stack 115 as including a single first layer 119ₐ and a single second layer 121_{b}. It should be understood that such illustration is for the sake of explanation and ease of understanding, but that multiple first and second layers 119ₐ, 121_{b} may be used. In some embodiments AR stack 115 includes a plurality of alternating first and second layers 119ₐ, 121_{b}, wherein the first layers 119ₐ have a higher refractive index than the second layers 121_{b}, and the total number of first and second layers 119ₐ, 121_{b} ranges from 3 to 20 or more, such as from 3 to 10. Without limitation, in some embodiments the AR stack 115 is formed by a plurality of alternating first and second layers 119ₐ, 121_{b}, wherein the first layers 119ₐ have a higher refractive index than the second layers 121_{b}, and the total number of first and second layers 119ₐ, 121_{b} is 6. In those or other embodiments, one of the first layers 119ₐ is the lowermost layer of the AR stack 115, and is formed on (e.g., directly on) the surface of the adhesion layer 113. That concept is shown in FIG. 8A, which depicts one example in of a multilayer AR article 100 consistent with the present disclosure, wherein AR stack 115 includes a total of six alternating first and second layers 119ₐ, 121_{b}, where a and b are integers ranging from 1 to 3. In any case it should be understood that the AR stack 115 is configured to enhance the antireflection effect of multilayer AR article 100. Following formation of the AR stack 115, a layer stack 511 may be obtained, as shown in FIGS. 5D and 8A.

The composition of the layers within the AR stack 115 may vary widely, and any suitable material may be used to form such layers. Without limitation, in some embodiments the first and second layers 119ₐ, 121_{b} are each formed from a metal (e.g., Ti, Si, Zr, Mg, Ta etc.), a metal oxide (e.g., SiO, SiO₂, TiO₂, ZrO, MgO, TaO, Ta₂O₅ etc.), a metal nitride (e.g., SiₓN_{y}, TiN, ZrN, TaN, etc.), combinations thereof and the like. Without limitation, in some embodiments the first layers 119ₐ are formed from TiO₂, and the second layer 121_{b} are formed from SiO₂. Thus, in the embodiments of FIG. 8A, AR stack 115 may include alternating SiO₂ and TiO₂ layers, wherein the total number of layers in AR stack 115 is six.

While the present disclosure focuses on embodiments in which AR stack 115 includes two different types of layers (i.e., layers 119ₐ and 121_{b}), the instant application is not limited to such configurations. Indeed, the present disclosure envisions embodiments in which AR stack 115 includes more than 2 (e.g., 3, 4, 5 etc.) different types of layers therein, wherein each type of such layers differ in composition from each other type of layer in the AR stack 115.

The layers of AR stack 115 may be formed in any suitable manner. For example, the layers 119ₐ, 121_{b} may be formed using a PE-CVD process, such as the PE CVD process described above with regard to the formation of adhesion layer 113. Of course, the layers 119ₐ, 121_{b} may be made by other processes, such as but not limited to physical vapor deposition (e.g., thermal evaporation, sputtering, magnetron sputtering, etc.), atomic layer deposition, wet deposition methods, combinations thereof, and the like.

The thickness of the individual layers making up the AR stack 115 may vary widely. In general, the thickness of the layers 115 may be tuned to work in conjunction with the moth eye layer 111 and the adhesion layer 113. In general, however, the thickness of the layers within the AR stack may have a thickness ranging from greater than 0 to about 250 nm or more, such as from greater than 0 to about 150 nm, from greater than 0 to about 100 nm, or even greater than 0 to about 90 nm. In some embodiments, the AR stack 115 includes a plurality of alternating high and low refractive index layers (119ₐ, 121_{b}, respectively), wherein the thickness of each of those layers is within the range of about 1 to about 90 nm. In those or other embodiments, the high refractive index layers 119ₐ may be TiO₂, and the low refractive index layers 121_{b} may be SiO₂. In any case, the makeup and thicknesses of the layers in AR stack 115 may be selected such that AR stack provides a wide band antireflective effect in wavelength range of about 400 to about 700 nm. That is, in embodiments that AR stack provides an AR effect across the entire visible range of the electromagnetic spectrum.

The upper surface of the AR stack 115 may have a surface roughness that is different from the surface roughness of the as-deposited adhesion layer 113 and the as-formed moth eye layer 111. For example, the upper surface of the AR stack 115 may have a surface roughness (R3), the upper surface of the as-deposited adhesion layer 113 may have a surface roughness (R2), and the upper surface of the as-formed moth eye layer 111 may have a surface roughness (R1), wherein R3<R2<R1.

To demonstrate that concept reference is made to FIG. 8B, which is an SEM image of the upper surface 512 of layer stack 511 or, more specifically, of the upper surface of the uppermost layer of antireflective stack 115. In this embodiment, the AR stack 115 included a plurality of alternating TiO₂ (119ₐ) and SiO₂ (119_{b}) layers arranged as shown in FIG. 8A, wherein the thickness of the respective layers in the AR stack 115 was as shown in table 1 below.

TABLE 1
Layer thicknesses for an example AR stack

| Layer | Thickness (nm) |
|---|---|
| 121₃ (SiO₂) | 89.05 |
| 119₃ (TiO₂) | 36.50 |
| 121₂ (SiO₂) | 11.12 |
| 119₂ (TiO₂) | 43.52 |
| 121₁ (SiO₂) | 43.32 |
| 119₁ (TiO₂) | 9.52 |
| 113 (SiO₂) | 37.00 |

As can be seen form FIG. 8B, the surface roughness created by the formation of the moth eye layer 111 is largely covered (eliminated) following deposition of AR stack 115.

It is emphasized that the layer thicknesses enumerated in table 1 are for the sake of example only, and the present disclosure is not limited thereto. Indeed, as discussed above and further demonstrated in the examples, the thicknesses of the layers in the AR stack are generally tuned to operate in conjunction with the moth eye layer 111 and adhesion layer 113. That is, the AR stack 115 is designed taking into account that the moth eye layer 111 functions as an optical element in the layer stack. This is unlike typical AR stack design, which does not consider structures created by a plasma etch as optical elements that are accounted for when determining the structure of an AR stack. As will be shown in the examples, however, the simulated performance of the multilayer AR articles described herein may differ from their actual performance if the moth eye layer 111 is not accounted for in the design of the AR stack 115.

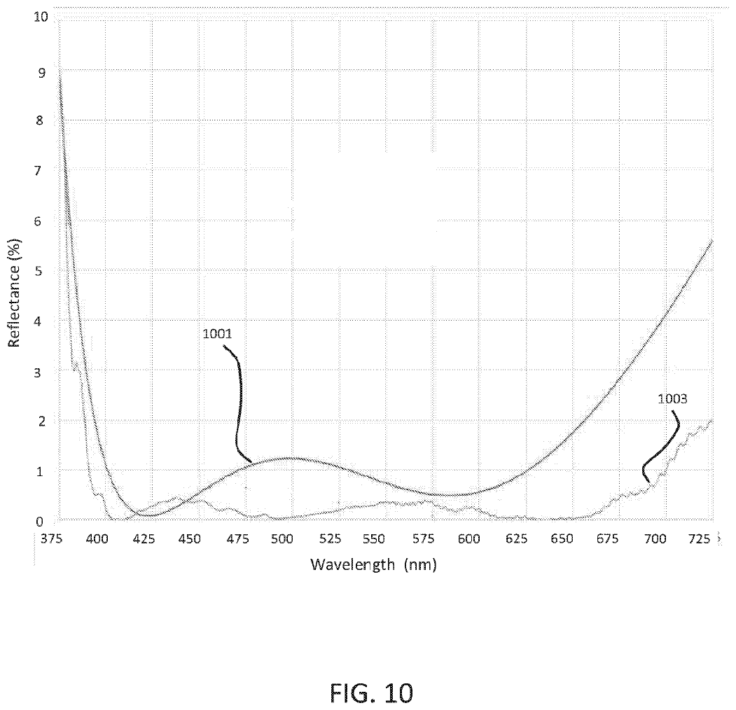

Contrary to conventional AR design procedures, the inventor has found that the moth eye layer 111 formed by plasma treating a hard coating on base structure 101 significantly affects the optical performance of a multilayer AR article consistent with the present disclosure. Indeed, in some embodiments to achieve the optical performance reported herein, the thicknesses of the layers within AR stack 115 were be calculated/tuned based on the use of a “composite substrate,” as a single optical element of a multilayer AR article, wherein the composite substrate includes base structure 101, moth eye layer 111, and adhesion layer 113. Design of the AR stack 115 may therefore be based on the composite surface reflectance exhibited by layer stack 509 of FIG. 5C (i.e. a stack including the base structure 101, moth eye layer 111, and adhesion layer 113). Failure to utilize such a composite substrate in the design phase may result in disparities between the calculated/simulated performance of the design and the real-world performance of the design, as shown in FIG. 10 and described in the example below.

The impact of the moth eye layer 111 on the optical properties of the multilayer AR article 100 may be demonstrated by comparing the measured reflectance of the multilayer article in the visible region to the reflectance of the AR stack without considering moth eye layer 111. In that regard reference is made to FIG. 10, which compares a plot of optical model reflectance (1001) with a plot of the actual reflectance (1003) of a multilayer AR article 100 over the visible spectrum from 375 to 725 nm. Plot 1001 was obtained by optical modeling of just the AR stack 115 and adhesion layer 113 consistent with Table 1 on a base substrate with hard coating 101. Plot 1003 is the measured reflectance of multilayer AR article 100 consistent with FIG. 5d and layer thickness consistent with Table. 1. The difference between plot 1003 vs. plot 1001 shows that the moth eye effect of layer 111 remains within multilayer AR article 100 and contributes to the reflection reduction effect of the overall article.

As understood in the art, AR performance involving human interaction (in these embodiments, display of mobile device) is often quantified by measurement or calculation of photopic reflectance, bandwidth and L*a*b* reflected color.
Photopic reflectance mimics the response of human eye and is calculated by the integrated product of light reflectance and human eye sensitivity over the visible wavelength bandwidth.
Bandwidth is often discussed as the range of wavelength that the AR is effective in reducing reflectance to less than 1%.
L*a*b* is a perceived reflected color of AR coating by human eyes and calculated according to CIELAB colorspace. It's preferable in interactive display applications such as mobile devices for the reflected color to be neutral, or |a*|<2 and |b*|<2

Specifically, from FIG. 10, the advantages of plot 1003 include:
The photopic reflectance of plot 1003 is determined to be less than 0.5%, whereas the photopic reflection of plot 1001 is greater than 1%. This translates to more than 50% reduction in photopic reflectance of the overall AR article including the moth eye layer over the AR stack alone.
Bandwidth of plot 1001 is determined to be between 400 nm-625 nm (range of 225 nm) whereas the bandwidth of plot 1003 is between 390 nm-700 nm (range of 310 nm). This translates to more than 35% of an increase in the bandwidth of the reflection reduction effect. It also important to note that the human visible wavelength is between 400-700 nm which is within the AR bandwidth of AR article 511.
a* and b* of plot 1001 is determined to be a*=−5.05, b*=0.26, whereas plot 1003 has a*=−0.56, b*=−0.86.

Following the formation of AR stack 115, a multilayer AR article 100 comprising a layer stack 511 consistent with FIG. 5D and/or FIG. 8A may be formed. At that point the multilayer AR article 100 may be considered complete, or it may be subjected to further processing to form one or more layers on (e.g., directly on) the surface of AR stack 115. In some embodiments, following formation of AR stack 115 an anti-smudge layer 117 is applied to the upper surface of AR stack 115. A wide variety of anti-smudge layers are known and any suitable anti-smudge layer may be used. In some embodiments, the anti-smudge layer 117 is an anti-fingerprint, anti-smudge fluoropolymer layer, such as those known in the art. Such layers may be applied in any suitable manner, such as by a wet coating process or a vacuum flash evaporation process. Without limitation, in some embodiments anti-smudge layer 117 is a fluoropolymer layer that is applied via a dip coating process.

The present disclosure is further detailed with respect to the following example, which is intended to illustrate specific example embodiments.

### Example

In applications such as mobile phone screen overlays, strong adhesion of an AR coating to a base structure may be considered an important design parameter. Indeed, if the AR coating does not sufficiently adhere to the base structure, its performance may deteriorate over time, and/or it may delaminate. This is particularly true in the context of smart phones and cell phones, where adhesion of an AR coating on a screen overlay may be severely tested when the device is used environments with elevated temperature and/or humidity, and when the device is repeatedly touched.

To investigate their usefulness for such applications several sample multilayer AR articles consistent with the present disclosure were prepared. A hard-coated PET film sold by the Japanese corporation Nippa under part number T-CPF100(75)-SL(35) (hereinafter, the Nippa film) was used as a base structure 100 for each sample. The Nippa film included a polyethylene terephthalate substrate 103 that was hard coated with silicon and oxygen containing polymeric hard coating 109.

Eight (8) 76×158 mm pieces of the Nippa film were cut and laminated onto eight (8) 82.5×165 mm pieces of borosilicate glass having a thickness of 1.1 mm. All 8 pieces of the Nippa film were mounted in side by side vertical orientation on a 475×1000×12.5 mm aluminum carrier so that they could be processed simultaneously.

The carrier was loaded into a single-ended vertical coating system that includes two process zones, one for plasma etch, and another for PE-CVD deposition. The coating system included a single AC ion source in the PECVD process zone. The carrier was initially placed in the plasma etch zone and subject to plasma etch to form a moth eye layer on the surface of hard coating of the Nippa film of each sample. The plasma etch was carried out by exposing the hard coating of each sample to a collimated beam of oxygen ions that were produced by operating an ion source at 2.5 kilovolts, 400 mA using oxygen as the active gas. The incident angle of the ion beam on the hard coating was 45 degrees. Plasma etch was carried out as the carrier was moved past the ion source at a rate of 0.5 meters per minute.

The carrier was then moved to the PE-CVD zone and a SiO₂ adhesion layer was deposited on the moth eye layer of each sample. Deposition of the adhesion layer was performed by PE-CVD using HMDSO as the precursor vapor, which was delivered with oxygen gas to the plasma source as the carrier was moved past the source. The ratio between oxygen and precursor vapor was 5:1 (120 sccm HMDSO, 600 sccm Oxygen), and the AC ion source was operated at 5.6 kW as the carrier was moved at a rate of 4 m/min. The resulting SiO₂ adhesion layer had a refractive index of 1.47 and a thickness of 37.12 nm.

Following deposition of the adhesion layer a multilayer AR stack including a total of three SiO₂ layers and three TiO₂ layers was deposited on the upper surface of the adhesion layer of each sample. The first layer deposited on the adhesion layer was a TiO₂ layer having a refractive index (RI) of 2.386 and a thickness of 9.52 nm. The layer was formed via PE-CVD using TiCl₄ as the precursor vapor, which was delivered to the plasma source with oxygen gas as the carrier was moved past the source. The ratio between oxygen and precursor vapor was 7.8:1 (77 sccm TiCl4, 600 sccm Oxygen) and the AC ion source was operated at 10.8 kW while the carrier moved at a rate of 2.35 m/min.

A first layer of SiO₂ was then deposited on the first layer of TiO₂. The first layer of SiO₂ had a refractive index (RI) of 1.465 and a thickness of 43.32 nm. Deposition of the first layer of SiO₂ was performed using PE-CVD using HMDSO as the precursor gas, which was delivered with oxygen to the plasma source as the carrier was moved past the source. The ratio of HMDSO to oxygen was 6.4:1 (55 sccm HMDSO, 350 sccm Oxygen), and the AC ion source was operated at 9.4 kW as the carrier was moved at 1.769 m/min.

Second and third layers of both TiO₂ and SiO₂ were then alternatingly deposited in much the same manner as the first and second TiO₂ and SiO₂ layers, using the following processing parameters: second TiO₂ layer (RI 2.386, physical thickness 43.52 nm, 10.8 kW, 77 sccm TiCl4, 600 sccm Oxygen, Carrier speed 0.503 m/min); second SiO₂ layer (RI 1.465, physical thickness 11.12 nm, 8.3 kW, 22 sccm HMDSO, 350 sccm Oxygen, Carrier Speed 3.285 m/min); third TiO₂ layer (RI 2.386, physical thickness 36.50 nm, 10.8 kW, 77 sccm TiCl4, 600 sccm Oxygen, Carrier speed 0.709 m/min); and then third SiO₂ (RI 1.465, physical thickness 89.05 nm, 9.4 kW, 55 sccm HMDSO, 350 sccm Oxygen, Carrier Speed 0.77 m/min). The resulting multilayer AR articles had the general layer structure shown in FIG. 5D.

Following the formation of the AR stack, a fluoropolymer anti-smudge coating was provided on some of the samples via dip coating. The resulting multilayer AR articles had the general structure of the multilayer AR article shown in FIGS. 5E and 8A.

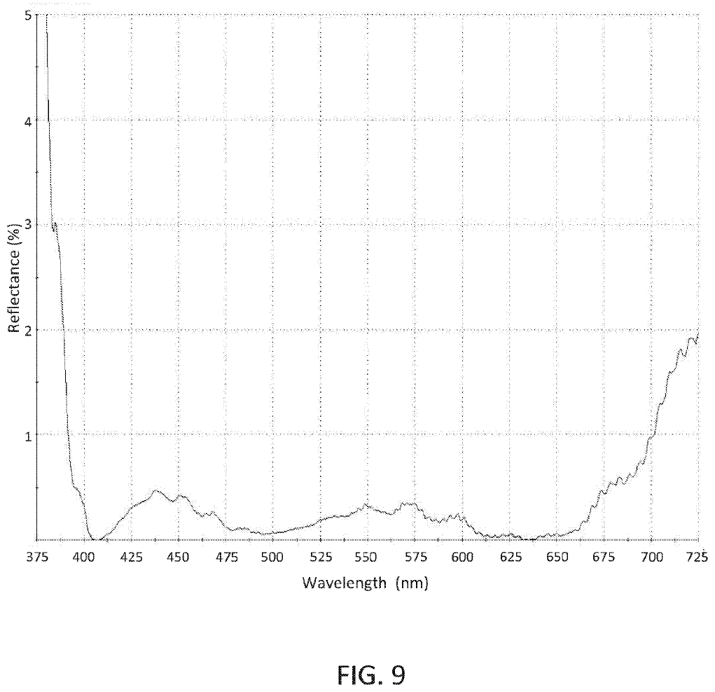

To evaluate their optical performance, one of the multilayer AR articles was applied to the display of a smart phone and the reflectance of the sample in the visible region of the electromagnetic spectrum was measured. The results are shown in FIG. 9, which is a plot of reflectance (in percent) versus wavelength (in nm). As shown, the same exhibited a reflectance less than 1% of visible light over the wavelength range of about 400 to about 700 nm.

To evaluate their scratch resistance, some of the prepared multilayer AR articles were subject to scratch testing. Such testing was performed using an automated scratch tester with 0000 steel wool covering a 1 cm² “finger” and using a 500 gram weight. After more than 200 cycles, the samples showed no visible signs of wear. The samples also showed no change in haze, as confirmed by haze measurements performed with a Haze-guard haze testing apparatus.

To evaluate the adhesion strength of the AR stack and other layers, some of the multilayer AR articles prepared above were subject to a rigorous adhesion test. The adhesion test utilized a grid and tape method that, if passed, can help to ensure satisfactory performance of the multilayer AR article in real world applications, such as an overlay of mobile device display.

The adhesion test performed was as follows. Following deposition of the AR stack 115, a 10×10 grid of 1 mm×1 mm squares was formed in the samples that were not coated with a fluoropolymer anti-smudge layer. The grid was cut through the AR stack, the adhesion layer, and into the moth eye layer using a razor blade. Tape (3M® SCOTCH® Invisible Tape) was then pressed firmly down over the cut grid area and pulled off sharply. The grid area was then visually inspected for coating delamination, which may range from complete removal of grid squares to partial coating removal at the edges. No delamination was observed in the tested samples following the initial tape test.

The test samples were then placed in an environmental chamber set at 50 degrees Celsius and 90% humidity. After three days the tape test was reiterated using the same grid, and no delamination was observed. The samples were then returned to the environmental chamber and the test was reiterated every three days for a total of thirty days. No delamination of any of the grid squares was observed for any of the samples over the entire period of the test.

To demonstrate the impact of the moth eye layer on the design of the AR stack, optics software was utilized to calculate a simulated reflectance of the sample structures produced above using convention AR design techniques. Specifically, optics software was used to calculate the simulated reflectance of the samples based on the use of the Nippa film, and the adhesive layer as discrete optical components in the layer structure, and without considering the impact of the moth eye layer. The simulated reflectance data produced for the structure is plotted as plot 1001 in FIG. 10. The measured reflectance of the samples is plotted in the same figure as plot 1003. As can be seen, there is a significant discrepancy between the simulated data (1001) and the real-world data 1003, demonstrating the need to take the moth eye layer into account when calculating the design of the AR stack.

As used herein, the terms “about” and “substantially” when used in connection with a numerical value or range means+/−5% of the recited numerical value or range.

As used herein, the term “on” may be used to describe the relative position of one component (e.g., a first layer) relative to another component (e.g., a second layer). In such instances the term “on” should be understood to indicate that a first component is present above a second component but is not necessarily in contact with one or more surfaces of the second component. That is, when a first component is “on” a second component, one or more intervening components may be present between the first and second components. In contrast, the term “directly on” should be interpreted to mean that a first component is in contact with a surface (e.g., an upper surface) or a second component. Therefore, when a first component is “directly on” a second component, it should be understood that the first component is in contact with the second component, and that no intervening components are present between the first and second components.

As may be appreciated from the foregoing, the multilayer AR article described herein can include a highly adherent, broad band antireflective coating (e.g., layers 111-115 and optionally 117) on a base structure 101 (e.g., a polymer substrate 103 including a hard coating 109). The multilayer AR articles can retain the benefits of a moth eye effect provided by a moth eye layer (e.g., layer 111) and combines that effect with a multilayer AR stack that can withstand rigorous adhesion testing. As a result, the multilayer AR articles consistent with the present disclosure can be advantageously used in challenging applications, such as overlay screen protectors for mobile devices (smart phones, tablets, laptops, etc.) and automotive displays.

### Embodiments

The following are presented as additional embodiments of the present disclosure:

Embodiment 1: According to this embodiment there is provided a multilayer antireflective article, comprising: a base structure comprising a substrate and a hard-coat layer on an upper surface of the substrate; a moth eye layer etched into said hard-coat layer, an adhesion layer on said moth eye layer, wherein said adhesion layer is bonded to said moth eye layer and an antireflective (AR) stack on said adhesion layer, said AR stack comprising a plurality of layers of differing refractive indexes; wherein the multilayer antireflective article exhibits an improved photopic reflectance that is at least 50% lower than photopic reflectance of said multilayer antireflective article without said moth eye layer.

Embodiment 2: This embodiment includes any or all of the feature of embodiment 1, wherein the multilayer antireflective article exhibits an improved bandwidth in which reflectance is less than 1% that is more than 35% wider than bandwidth of said multilayer antireflective article without said moth eye layer.

Embodiment 3: This embodiment includes any or all of the feature of embodiment, wherein the multilayer antireflective article exhibits a neutral reflectance color with |a*|<2 and |b*|<2.

Embodiment 4: This embodiment includes any or all of the features of embodiment 1, wherein the multilayer antireflective article exhibits a bandwidth in which reflectance is less than 1% over the visible wavelength range of 400 nm-700 nm.

Embodiment 5: This embodiment includes any or all of the features of embodiment 1, wherein the multilayer antireflective article exhibits a photopic reflectance that is less than 0.5%.

Embodiment 6: This embodiment includes any or all of the features of embodiment 1, wherein the multilayer antireflective article exhibits an adhesion strength that can withstand at least 30 days in environment of at least 50° C. and at least 90% humidity without delamination in standard grid & tape test.

Embodiment 7: This embodiment includes any or all of the features of embodiment 1, wherein the AR stack includes at least 4 layers of different refractive indexes.

Embodiment 8: This embodiment includes any or all of the features of embodiment 1, wherein said adhesion layer is not conformal to the upper surface of said moth eye layer.

Embodiment 9: This embodiment includes any or all of the features of embodiment 1, wherein an upper surface of the moth eye layer has a first surface roughness (R1), an upper surface of the adhesion layer has a second surfaced roughness (R2), and an upper surface of the AR stack has a third surface roughness (R3), wherein R1>R2>R3.

Embodiment 10: According to this embodiment there is provided a multilayer antireflective article, comprising: a base structure comprising a substrate and a hard-coat layer on an upper surface of the substrate; a moth eye layer etched into said hard-coat layer, an adhesion layer disposed on and not conformal to said moth eye layer.

Embodiment 11: According to this embodiment there is provided a multilayer antireflective article, comprising: a base structure comprising a substrate and a hard-coat layer on an upper surface of the substrate; a moth eye layer etched into said hard-coat layer, an adhesion layer disposed on said moth eye layer; wherein the surface roughness of said article with said adhesion layer is less than the surface roughness of said article without said adhesion layer and, wherein the reflectance of said article including said adhesion layer is increased by less than 1.0% over the reflectance of said article without the addition of said adhesion layer over the visible wavelength range of 400 nm-700 nm.

Other than in the examples, or where otherwise indicated, all numbers expressing endpoints of ranges, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the present disclosure are approximations, unless otherwise indicated the numerical values set forth in the specific examples are reported as precisely as possible. Any numerical value, however, inherently contains certain errors necessarily resulting from the standard deviation found in their respective testing measurements.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A multilayer antireflective article, comprising:
a base structure comprising a substrate and a hard-coat layer on an upper surface of the substrate;
a moth eye layer etched into said hard-coat layer;
an adhesion layer on said moth eye layer, wherein said adhesion layer is bonded to said moth eye layer; and
an antireflective (AR) stack on said adhesion layer, said AR stack comprising a plurality of layers of differing refractive indexes;
wherein the multilayer antireflective article exhibits an improved photopic reflectance that is at least 50% lower than photopic reflectance of said multilayer antireflective article without said moth eye layer.

2. A multilayer antireflective article as in claim 1;
wherein the multilayer antireflective article exhibits an improved bandwidth in which reflectance is less than 1% that is more than 35% wider than bandwidth of said multilayer antireflective article without said moth eye layer.

3. A multilayer antireflective article as in claim 1;
wherein the multilayer antireflective article exhibits a neutral reflectance color with |a*|<2 and |b*|<2.

4. A multilayer antireflective article as in claim 1;
wherein the multilayer antireflective article exhibits a bandwidth in which reflectance is less than 1% over the visible wavelength range of 400 nm-700 nm.

5. A multilayer antireflective article as in claim 1;
wherein the multilayer antireflective article exhibits a photopic reflectance that is less than 0.5%.

6. A multilayer antireflective article as in claim 1;
wherein the multilayer antireflective article exhibits an adhesion strength that can withstand at least 30 days in environment of at least 50° C. and at least 90% humidity without delamination in standard grid & tape test.

7. A multilayer antireflective article as in claim 1;
wherein the AR stack includes at least 4 layers of different refractive indexes.

8. A multilayer antireflective article as in claim 1;
wherein said adhesion layer is not conformal to the upper surface of said moth eye layer.

9. The multilayer antireflective article of claim 1, wherein an upper surface of the moth eye layer has a first surface roughness (R1), an upper surface of the adhesion layer has a second surfaced roughness (R2), and an upper surface of the AR stack has a third surface roughness (R3), wherein R1>R2>R3.

10. A multilayer antireflective article, comprising:
a base structure comprising a substrate and a hard-coat layer on an upper surface of the substrate;
a moth eye layer etched into said hard-coat layer,
an adhesion layer disposed on and not conformal to said moth eye layer.

11. A multilayer antireflective article, comprising:
a base structure comprising a substrate and a hard-coat layer on an upper surface of the substrate;
a moth eye layer etched into said hard-coat layer,
an adhesion layer disposed on said moth eye layer
wherein the surface roughness of said article with said adhesion layer is less than the surface roughness of said article without said adhesion layer and,
wherein the reflectance of said article including said adhesion layer is increased by less than 1.0% over the reflectance of said article without the addition of said adhesion layer over the visible wavelength range of 400 nm-700 nm.
